(19) United States
(12) Patent Application Publication
(10) Pub. No.: US 2008/0264390 A1
(43) Pub. Date: Oct. 30, 2008

(54) Injection Valve for Injecting Fuel and Cylinder Head

(76) Inventors: Klaus Rottenwohrer, Regensburg (DE); Andreas Weigand, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/816,143

(22) PCT Filed: Feb. 13, 2006
(86) PCT No.: PCT/EP2006/050900

§ 371 Date: Sep. 26, 2007

(30) Foreign Application Priority Data
Feb. 14, 2005 (DE) 10 2005 006 641.0

(51) Int. Cl. F02M 61/14

(52) U.S. Cl. 123/470; 239/533.2

(57) ABSTRACT

An injection valve (1) can be fitted into a cavity (4) of a cylinder head (5) of an internal combustion engine. The valve has at least one injection orifice (6) and a nozzle body (2) with a nozzle body shaft (8). The nozzle body shaft (8) has a coupling element (11), which projects radially from the nozzle body shaft (8) and when the injection valve (1) has been fitted, mechanically couples the nozzle body shaft (8) to the lateral area (10) of the cavity (8) of the cylinder head (5) in a radial direction.

### CROSS-REFERENCE TO RELATED APPLICATIONS

This application is a U.S. national stage application of International Application No. PCT/EP2006/050900 filed Feb. 13, 2006, which designates the United States of America, and claims priority to German application number 10 2005 006 641.0 filed Feb. 14, 2005, the contents of which are hereby incorporated by reference in their entirety.

### TECHNICAL FIELD

The invention relates to an injection valve, which can be fitted into a cavity of a cylinder head of an internal combustion engine, with at least one injection orifice and with a nozzle body, which comprises a nozzle body shaft. The invention also relates to a cylinder head for an internal combustion engine, having a cavity, into which an injection valve can be fitted.

### BACKGROUND

Increasingly strict legal provisions relating to permissible pollutant emissions from internal combustion engines disposed in motor vehicles mean that various measures have to be taken to reduce pollutant emissions. One approach is to reduce the pollutant emissions produced by the internal combustion engine. Soot formation is very much dependent on the concentration of the air/fuel mixture in the respective cylinder of the internal combustion engine.

An improved mixture concentration can be achieved, if fuel is injected into a combustion chamber of the internal combustion engine at very high pressure by way of an injection valve through at least one injection orifice. Combining high pressure and at least one small injection orifice allows a very fine spray pattern to be produced for the fuel in the combustion chamber. The at least one small injection orifice however has the disadvantage that more deposits form than with a larger injection orifice. The deposits can be the result of coking for example.

### SUMMARY

The deposits at an injection valve can be reduced in a simple manner according to an embodiment of an injection valve, which can be fitted into a cavity of a cylinder head of an internal combustion engine, and may comprise at least one injection orifice and a nozzle body, which comprises a nozzle body shaft, the nozzle body shaft having a coupling element, which projects radially from the nozzle body shaft and when the injection valve has been fitted, couples the nozzle body shaft mechanically to a lateral surface of the cavity of the cylinder head in a radial direction.

According to another embodiment, a cylinder head for an internal combustion engine, may comprise a cavity, into which an injection valve with a nozzle body shaft can be fitted, and a coupling element on the cylinder head being configured on a lateral surface of the cavity, said coupling element coupling the nozzle body shaft mechanically to the lateral surface in a radial direction, when the injection valve has been fitted.

### BRIEF DESCRIPTION OF THE DRAWINGS

Exemplary embodiments of the invention are described in more detail below with reference to the schematic drawings, in which:

FIG. 1 shows a first embodiment of an arrangement of an injection valve in a cylinder head,

FIG. 2 shows a second embodiment of the arrangement of the injection valve in the cylinder head with a cooling unit,

FIG. 3 shows a third embodiment of the arrangement of the injection valve in the cylinder head,

FIG. 4 shows a cross-section through the injection valve according to FIG. 3,

FIG. 5 shows a fourth embodiment of the arrangement of the injection valve in the cylinder head,

FIG. 6 shows a fifth embodiment of the arrangement of the injection valve in the cylinder head,

FIG. 7 shows a sixth embodiment of the arrangement of the injection valve in the cylinder head,

FIG. 8 shows a section through the cylinder head according to FIG. 7 without an injection valve.

Elements of the same structure or function are marked with the same reference characters in all the figures.

### DETAILED DESCRIPTION

According to an embodiment, an injection valve, which can be fitted into a cavity of a cylinder head of an internal combustion engine, may comprise at least one injection orifice and a nozzle body, which comprises a nozzle body shaft, the nozzle body shaft having a coupling element, which projects radially from the nozzle body shaft and when the injection valve has been fitted, couples the nozzle body shaft mechanically to a lateral surface of the cavity of the cylinder head in a radial direction.

When the injection valve has been fitted into the cylinder head of the internal combustion engine, deposits can form on regions of the injection valve exposed to hot combustion gases during operation of the internal combustion engine. These deposits result at high temperatures for example due to the coking of fuel residues or due to combustion residues from the combustion gases. They can accumulate to such a degree that they extend into the fuel flow. This can disadvantageously change the spray pattern of a fuel in a combustion chamber of the internal combustion engine.

The arrangement of the coupling element on the nozzle body shaft between the nozzle body shaft of the injection valve and the lateral surface of the cavity of the cylinder head makes it possible during operation of the internal combustion engine to ensure efficient heat dissipation in a simple manner from the nozzle body shaft and from a region of the injection valve, in which the at least one injection orifice is disposed. This results in a lower temperature on average in the region in which the at least one injection orifice is disposed and on the nozzle body shaft and thus to more effective reduction of the formation of deposits at the at least one injection orifice.

In an advantageous refinement of the injection valve the coupling element on the nozzle body shaft has different radii along its axial extension. When suitable radii are selected, this makes it simple to fit the injection valve into the cavity of the cylinder head.

In a further advantageous refinement of the injection valve the coupling element on the nozzle body shaft is configured and disposed in such a manner that when the injection valve has been fitted, a free volume of the cavity in the cylinder head is separated in a sealing manner from the combustion chamber of the internal combustion engine. The free volume of the cavity is configured between the lateral surface of the cavity of the cylinder head and the nozzle body shaft of the injection valve and extends from the coupling element on the nozzle body shaft away from the at least one injection orifice. The axial length of the free volume can be varied by disposing the coupling element differently along the axial extension of the nozzle body shaft. During operation of the internal combustion engine the sealing effect of the coupling element on the nozzle body shaft can effectively prevent the hot combustion gases from the combustion chamber entering the free volume and heating the nozzle body shaft by way of the free volume. The part of the nozzle body shaft adjacent to the free volume forms a heat sink. This results in effective heat dissipation from the region of the injection valve, in which the at least one injection orifice is disposed.

In a further advantageous refinement of the injection valve the coupling element is disposed on the nozzle body shaft in such a manner that when the injection valve has been fitted, it is disposed in an axial end region of the cavity, which faces the combustion chamber of the internal combustion engine. In this instance the coupling element on the nozzle body shaft can be disposed flush with a combustion chamber wall of the cylinder head, which faces the combustion chamber. However the coupling element can also be disposed on the nozzle body shaft in an axial end region of the nozzle body shaft, which faces the injection orifice. The axial length of the axial end region of the nozzle body shaft here corresponds to around 10% of the axial length of the nozzle body shaft. This means that a particularly large part of the nozzle body shaft is protected from hot combustion gases during operation of the internal combustion engine.

In a further advantageous refinement of the injection valve the coupling element on the nozzle body shaft is configured and disposed in such a manner that when the injection valve has been fitted, it forms a thermal coupling between the nozzle body shaft of the injection valve and the lateral surface of the cavity of the cylinder head in a radial direction.

This means that heat can flow away efficiently by way of the coupling element on the nozzle body shaft into the cylinder head, said heat being absorbed by the nozzle body shaft during operation of the internal combustion engine.

In a further advantageous refinement of the injection valve the coupling element is configured on at least one predetermined segment of the periphery of the nozzle body shaft. The predetermined segment of the periphery is understood to be a part of the periphery. The coupling element can be configured in such a manner that it does not run round the entire periphery of the nozzle body shaft but is interrupted. If the lateral surface of the cavity of the cylinder head has any inaccuracy in respect of its roundness, it may be possible to compensate for this when fitting the injection valve into the cavity of the cylinder head by rotating the injection valve about its longitudinal axis.

In a further advantageous refinement of the injection valve the coupling element on the nozzle body shaft is disposed in such a manner that when the injection valve has been fitted, it is coupled to the cylinder head in a coupling region, in which the cylinder head demonstrates a predetermined temperature gradient during operation of the internal combustion engine. This allows a predetermined heat dissipation from the nozzle body shaft into the cylinder head, the cylinder head preferably having a suitably large temperature gradient in the coupling region.

In a further advantageous refinement of the injection valve the coupling element is disposed on the nozzle body shaft in such a manner that when the injection valve has been fitted, it is at a predetermined distance from a cooling unit of the cylinder head. If the distance from the cooling unit of the cylinder head is preferentially short, the heat dissipation is particularly efficient.

In a further advantageous refinement of the injection valve the coupling element on the nozzle body shaft comprises copper. Copper is a relatively soft metal with a high thermal conductivity coefficient. If the coupling element on the nozzle body shaft is relatively soft, it is easy to mount the injection valve. The high thermal conductivity coefficient of the copper allows particularly efficient thermal coupling of the nozzle body shaft of the injection valve to the lateral surface of the cavity of the cylinder head.

In a further advantageous refinement of the injection valve the coupling element is configured as a layer on the nozzle body shaft. The layer can either be applied in a simple manner to the nozzle body shaft of the injection valve or a plurality of materials can be used to form the layer.

In this context it is advantageous, if the layer comprises carbon. A layer of graphite, which is formed from carbon, can preferably be configured in a simple manner on the nozzle body shaft with an interference fit in respect of the cavity in the cylinder head. Graphite is also heat-resistant.

In a further advantageous refinement of the injection valve the layer on the nozzle body shaft comprises a thermally conductive paste. This can be applied in a simple manner to the nozzle body shaft and allows a particularly efficient thermal coupling of the nozzle body shaft of the injection valve to the lateral surface of the cavity of the cylinder head.

In a further advantageous refinement of the injection valve the coupling element on the nozzle body shaft comprises an elastically deformable material. The coupling element on the nozzle body shaft can thus preferably be configured with an interference fit in respect of the cavity in the cylinder head. It is also simple to fit the injection valve into the cavity of the cylinder head, if the coupling element on the nozzle body shaft comprises an elastically deformable material.

In a further advantageous refinement of the injection valve the coupling element is configured as a single piece with the nozzle body shaft. The coupling element can thus be produced with the nozzle body shaft in one work stage.

According to another embodiment, a cylinder head for an internal combustion engine, having the cavity, into which the injection valve can be fitted with the nozzle body shaft, may comprise a coupling element on the cylinder head being configured on the lateral surface of the cavity, coupling the nozzle body shaft mechanically to the lateral surface in a radial direction, when the injection valve has been fitted.

If the injection valve is fitted into the cylinder head of the internal combustion engine, the coupling element on the cylinder head, which couples the nozzle body shaft of the injection valve to the lateral surface of the cavity of the cylinder head, allows efficient heat dissipation by way of the nozzle body shaft in a simple manner. This results in a lower temperature on average in the region of the injection valve, in which the injection orifice is configured, thereby effectively reducing the formation of deposits at the at least one injection orifice. The injection valve can be used without a coupling element here to operate the internal combustion engine.

It is also advantageous if the coupling element on the cylinder head has different radii along its axial extension. When suitable radii are selected, this makes it simple to fit the injection valve into the cavity of the cylinder head.

In an advantageous refinement of the cylinder head the coupling element on the cylinder head is configured and disposed in such a manner that when the injection valve has been fitted, the free volume between the lateral surface of the cavity and the nozzle body shaft is separated from the combustion chamber of the internal combustion engine in a sealing manner. The free volume is configured between the lateral surface of the cavity of the cylinder head and the nozzle body shaft of the injection valve and extends from the coupling element on the cylinder head away from the combustion chamber. The part of the nozzle body shaft adjacent to the free volume is thus protected from the hot combustion gases in the combustion chamber during operation of the internal combustion engine and forms a heat sink. This results in efficient heat dissipation from the region of the injection valve, in which the at least one injection orifice is disposed.

It is also advantageous if the coupling element is disposed on the cylinder head in such a manner that when the injection valve has been fitted, it is disposed in the axial end region of the cavity. This means that a particularly large part of the nozzle body shaft is protected from hot combustion gases during operation of the internal combustion engine.

In a further advantageous refinement of the cylinder head the coupling element is configured and disposed on the cylinder head in such a manner that when the injection valve has been fitted, it forms a thermal coupling between the nozzle body shaft of the injection valve and the lateral surface of the cavity of the cylinder head in a radial direction. This means that heat can flow away efficiently by way of the coupling element on the cylinder head into the cylinder head, said heat being absorbed by the nozzle body shaft during operation of the internal combustion engine.

It is also advantageous, if the coupling element on the cylinder head is disposed in such a manner that when the injection valve has been fitted, the nozzle body shaft is coupled to the cylinder head in the coupling region of the lateral surface, in which the cylinder head demonstrates a predetermined temperature gradient during operation of the internal combustion engine. This allows a predetermined heat dissipation from the nozzle body shaft into the cylinder head, wherein the coupling region of the lateral surface may preferably demonstrate a suitably large temperature gradient. In particular the coupling element on the cylinder head can be at a preferentially short distance from the cooling unit in the cylinder head.

A particularly efficient thermal coupling can also be achieved, if the coupling element on the cylinder head comprises copper.

In a further advantageous refinement of the cylinder head the coupling element is configured as a layer on the lateral surface of the cavity of the cylinder head. The layer can be applied in a simple manner to the lateral surface of the cavity of the cylinder head.

In this context it is particularly advantageous, if the layer comprises a thermally conductive paste. The thermally conductive paste can be applied in a simple manner to the lateral surface of the cavity of the cylinder head and allows efficient thermal coupling.

The layer can also comprise carbon. A layer of graphite, which is formed from carbon, can preferably be configured in a simple manner on the lateral surface of the cavity in the cylinder head with an interference fit in respect of the nozzle body shaft. Graphite is also heat-resistant.

In a further advantageous refinement of the cylinder head the coupling element is configured on at least one predetermined segment of the periphery of the lateral surface of the cavity. The predetermined segment of the periphery is understood to be a part of the periphery. The coupling element on the cylinder head can be configured in such a manner that it does not run within the entire periphery of the lateral surface but is interrupted. If the nozzle body shaft has any inaccuracy in respect of its roundness, it may be possible to compensate for this when fitting the injection valve into the cavity of the cylinder head by rotating the injection valve about its longitudinal axis

It is also simple to fit the injection valve, if the coupling element on the cylinder head comprises an elastic material. The coupling element on the cylinder head can however also be configured as a single piece with the cylinder head. This is simple with regard to production of the coupling element on the cylinder head.

The coupling element can also be formed from a fluid, which is poured into the cavity of the cylinder head between the nozzle body shaft and the lateral surface of the cavity in the cylinder head, after the injection valve has been mounted, and then hardened. This allows the coupling element to be configured with an appropriate fit in a simple manner.

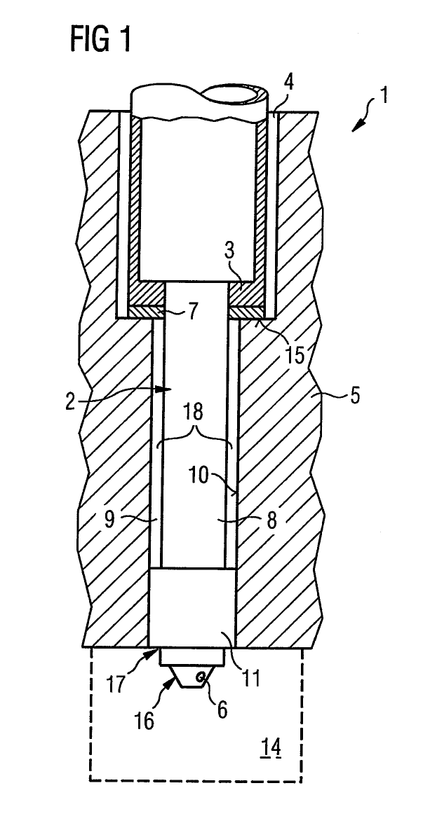

A first embodiment of an arrangement of an injection valve 1 in a cylinder head 5 (FIG. 1) comprises the injection valve 1, which is disposed in a cavity 4 of the cylinder head 5, with the injection valve 1 and the cylinder head 5 being part of an internal combustion engine. The injection valve 1 comprises a nozzle body 2, which is partly accommodated in a nozzle clamping nut 3. The injection valve 1 has at least one injection orifice 6, by way of which fuel can be metered into a combustion chamber 14 of the internal combustion engine. The injection valve 1 can also have a number of injection holes as the injection orifice 6. An injector seal 7 is disposed around the nozzle body 2 adjacent to the nozzle clamping nut 3. The injector seal 7 separates a part of the cavity 4, in which the nozzle clamping nut 3 is disposed, in a sealing manner from a combustion-chamber-side region 9 of the cavity 4. The injector seal 7 here represents an axial coupling between the nozzle clamping nut 3 and an offset 15 of the cavity 4. The combustion-chamber-side region 9 of the cavity 4 extends from the offset 15 to an axial end of the cavity 4, which faces the combustion chamber 14. The nozzle body 2 is configured as a nozzle body shaft 8 between the injection orifice 6 and the injector seal 7. The nozzle body shaft 8 is partly disposed in the combustion-chamber-side region 9 of the cavity 4 and lies opposite a lateral surface 10 of the combustion-chamber-side region 9 of the cavity 4 there.

The injection valve 1 can be configured differently in respect of the embodiment of the injection orifice 6. If the injection valve 1 is configured to open inward, the nozzle body 2 encloses a nozzle needle, on an axial end of the nozzle body 2, which faces the combustion chamber. The nozzle body 2 then has at least one, preferably more injection holes as the injection orifice 6, said injection holes being disposed on the axial end of the nozzle body 2, which faces the combustion chamber. The position of the nozzle needle in the nozzle body 2 is controlled by an actuator (not shown). In a closed position the nozzle needle prevents a flow of fuel through the injection holes. In an open position the nozzle needle allows the flow of fuel through the injection holes.

If the injection valve 1 is configured to open outward, the nozzle needle projects out of a cavity in the nozzle body 2 at the axial end of the nozzle body 2 facing the combustion chamber. In the closed position the nozzle needle lies against the cavity in the nozzle body 2 in such a manner that the flow of fuel through the cavity in the nozzle body 2 is prevented. In the open position an annular gap is formed between the nozzle needle and the cavity in the nozzle body 2, which serves as an injection orifice 6 and through which the fuel can be metered into the combustion chamber 14 of the internal combustion engine.

The formation of deposits at the injection valve 1 depends on different parameters. The size of the injection orifice 6 has an impact on pollutant emissions and the formation of deposits. A small injection orifice 6 contributes to a fine spray pattern and therefore to low pollutant emissions but tends to cause deposits to form. The temperature of the injection valve 1 in the region 16 of the injection valve 1, in which the injection orifice 6 is disposed, also has an impact on the formation of deposits during operation of the internal combustion engine. The lower the temperature in the region 16 of the injection valve 1, in which the injection orifice 6 is disposed, the lesser the latter's tendency to form deposits. The nozzle body shaft 8 therefore has a coupling element 11 in an axial end region 17 on an axial end of the nozzle body shaft 8, said coupling element 11 facing the combustion chamber 14 when the injection valve 1 has been fitted. The coupling element 11 is configured and disposed on the nozzle body shaft 8 in such a manner that a free volume 18 of the cavity 4 is separated in a sealing manner from the combustion chamber 14. The free volume 18 is configured between the nozzle body shaft 8 of the injection valve and the cavity 4 of the cylinder head 5 and extends from the coupling element 11 away from the combustion chamber 14. This reduces the extent to which the nozzle body shaft 8 is heated by combustion gases, which result in the combustion chamber 14 during operation. The sealing effect of the coupling element 11 on the nozzle body shaft 8 results in efficient heat dissipation by way of the nozzle body shaft 8 from the region 16 of the injection valve 1, in which the injection orifice 6 is disposed. This results in an average drop in temperature in the region 16 and therefore to a lesser tendency to form deposits.

The coupling element 11 on the nozzle body shaft 8 comprises a graphite layer for example. This can be applied to the nozzle body shaft with an interference fit in respect of the cavity 4. When the injection valve 1 is subsequently fitted into the cavity 4 of the cylinder head, the graphite layer is then ground specifically to fit the cavity 4.

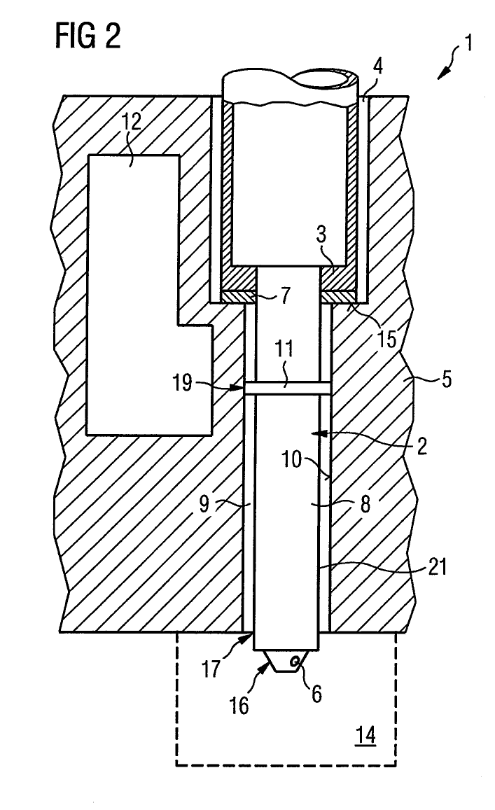

In a second embodiment of the arrangement of the injection valve 1 in the cylinder head 5 (FIG. 2) the coupling element 11 is disposed on the nozzle body shaft 8 in such a manner that the distance from a cooling unit 12 in the cylinder head 5 is kept as short as possible. During operation of the internal combustion engine a temperature gradient forms along the nozzle body shaft 8 and within the cylinder head 5. The coupling element 11 on the nozzle body shaft 8 can preferably be disposed in a coupling region 19 of the lateral surface 10, which demonstrates a suitably predetermined temperature gradient, preferably with a short distance to the cooling unit 12. The coupling element 11 on the nozzle body shaft 8 is also preferably formed from a material with good thermal conductivity. A material with good thermal conductivity in this context is one whose thermal conductivity coefficient X is greater than the thermal conductivity coefficient of the combustion gases. The heat resulting at the nozzle body shaft 8 during operation can thus be dissipated efficiently into the cylinder head 5 for the cooling unit 12 by way of the coupling element 11 on the nozzle body shaft 8.

The coupling element 11 on the nozzle body shaft 8 preferably may comprise copper. On the one hand copper has a very high thermal conductivity coefficient X and on the other hand the softness of the copper facilitates the fitting of the injection valve 1 into the cavity 4 of the cylinder head 5.

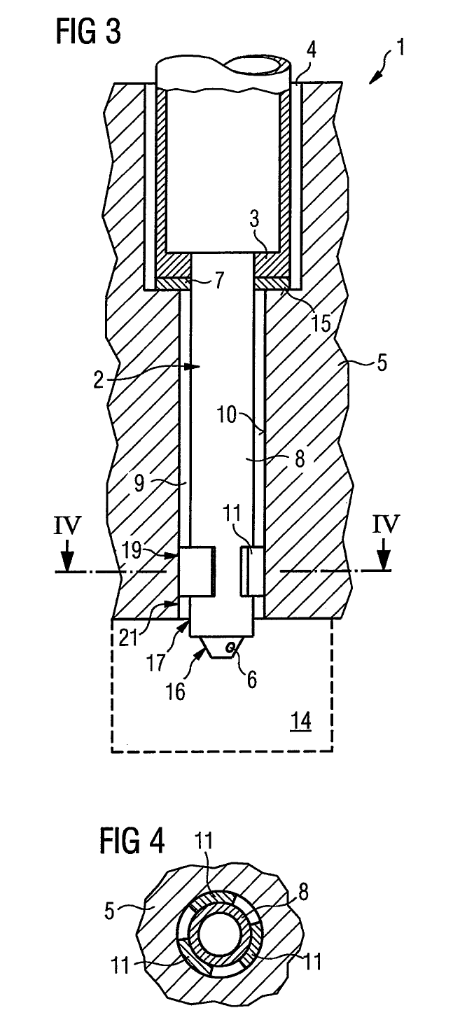

In a third embodiment of the arrangement of the injection valve 1 in the cylinder head 5 (FIG. 3) the coupling element 11 on the nozzle body shaft 8 has three individual segments (see FIG. 4). Any inaccuracy in the roundness of the cavity 4 in the combustion-chamber-side region 9 can thus be compensated for when the injection valve 1 is being mounted, by rotating the injection valve 1 about its longitudinal axis.

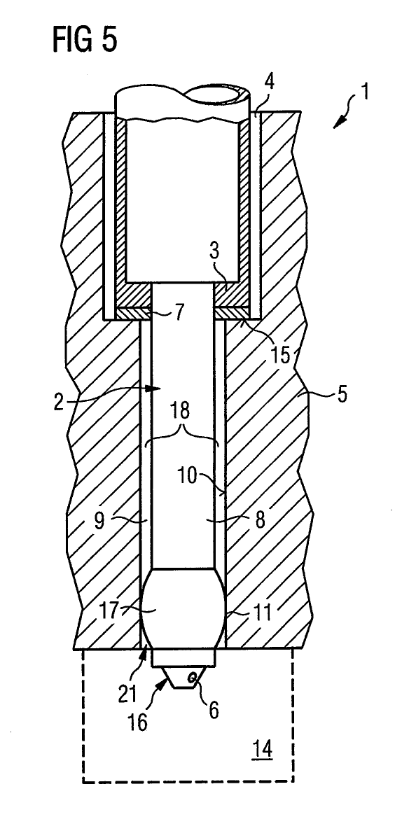

In a fourth embodiment of the arrangement of the injection valve 1 in the cylinder head 5 (FIG. 5) the coupling element 11 has different radii along its axial extension. In this instance the coupling element 11 is configured as spherical. The maximum radius of the bulge is selected such that the nozzle body shaft 8 and the lateral surface 10 are coupled. The coupling element 11 on the nozzle body shaft 8 can also be configured as cone-shaped, with the radius preferably decreasing toward the combustion chamber 14. These measures allow the injection valve 1 to be fitted in a simple manner into the cavity 4 of the cylinder head 5.

The coupling element 11 on the nozzle body shaft 8 can preferably comprise an elastic material and/or have an interference fit in respect of the cavity 4. Pressing the coupling element 11 on the nozzle body shaft 8 against the lateral surface 10 of the cavity 4 allows the free volume 18 to be separated in a sealing manner from the combustion chamber 14. If the coupling element 11 comprises an elastic material, it is possible to compensate for the waviness and any inaccuracy in the roundness of the cavity 4 by elastic deformation of the coupling element 11 on the nozzle body shaft 8 when fitting the injection valve 1 into the cylinder head 5.

The coupling element 11 on the nozzle body shaft 8 can preferably also be configured as a ring. This can then be pushed onto the nozzle body shaft 8 before the injection valve 1 is fitted into the cavity 4 of the cylinder head 5. The ring then preferably may comprise a material that can be deformed in a plastic and/or elastic manner.

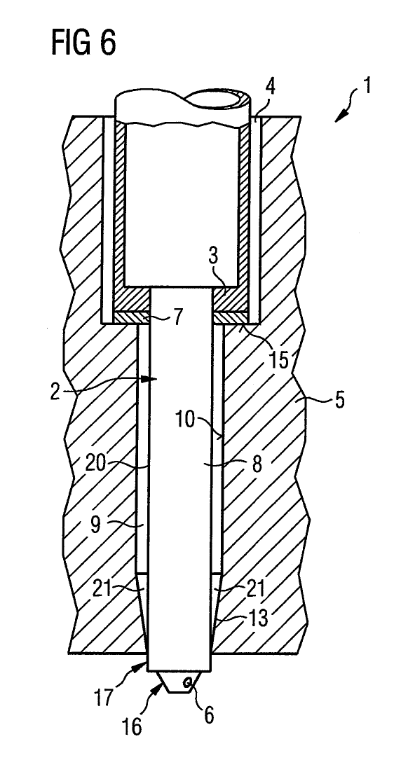

In a fifth embodiment of the arrangement of the injection valve 1 in the cylinder head 5 (FIG. 6) the coupling element 13 is configured as a tapering of the cavity 4 at the cylinder head 5. The coupling element 13 on the cylinder head 5 is configured and disposed in such a manner that it couples the nozzle body shaft 8 of the injection valve 1 mechanically to the lateral surface 10 of the cavity 4. The coupling element 13 on the cylinder head 5 here can be configured as a single piece with the cylinder head 5.

The coupling element 13 on the cylinder head 5 can preferably be configured and disposed in such a manner that when the injection valve 1 has been fitted, it couples the nozzle body shaft 8 of the injection valve 1 thermally to the lateral surface 10 of the cavity 4 and/or separates the free volume 18 of the cavity 4 in a sealing manner from the combustion chamber 14. The free volume 18 is then configured between the nozzle body shaft 8 of the injection valve and the cavity 4 of the cylinder head 5 and extends from the coupling element 11 away from the combustion chamber 14. The free volume 18 can preferably be configured to overlap with an axial end region 21, which is configured at the axial end of the cavity 4, which faces the combustion chamber 14.

The coupling element 13 on the cylinder head 5 can also be disposed in a manner different from that of the exemplary embodiments along the axial extension of the lateral surface 10 of the cavity 4 of the cylinder head 5. In particular the coupling element 13 on the cylinder head 5 can be disposed in the coupling region 19 of the lateral surface 10, which demonstrates a suitably predetermined temperature gradient during operation of the internal combustion engine. The coupling element 13 on the cylinder head 5 here can for example be at a predetermined, preferably short distance from the cooling unit 12 (see FIG. 2).

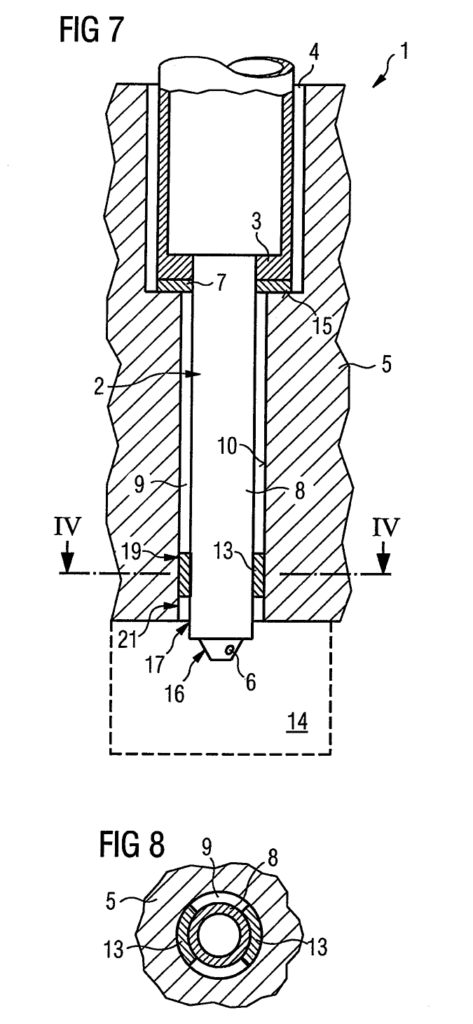

In a sixth embodiment of the arrangement of the injection valve 1 in the cylinder head 5 (FIG. 7) the coupling element 13 on the cylinder head 5 is disposed on two segments (see FIG. 8) along the periphery of the lateral surface 10 of the cavity 4 and couples the lateral surface 10 to the nozzle body shaft 8 on the injection valve 1. This measure allows any inaccuracies in the roundness of the nozzle body shaft 8 to be compensated for when the injection valve 1 is fitted.

Efficient thermal coupling by means of the coupling element 11 on the cylinder head 5 can be achieved by using a preferably large proportion of copper in the coupling element 11 on the cylinder head. It can also be improved by applying a layer, preferably of the thermally conductive paste. The coupling element 11 on the cylinder head can however also be formed solely from a correspondingly thick layer of the thermally conductive paste and/or another material with good thermal conductivity. The layer can however also contain a preferably high proportion of graphite.

The different embodiments can be combined with each other in any manner. Thus for example any embodiment of the coupling elements 11, 13 can comprise an elastic material, graphite, copper, thermally conductive paste, any material with good thermal conductivity or generally couple in a thermal manner. In the case of all embodiments, in which the coupling elements 11, 13 run around the entire periphery of the nozzle body shaft 8 or the cavity 4, the free volume 18 can be separated in a sealing manner from the combustion chamber 14. In the case of embodiments, in which the coupling elements 11, 13 are configured in segments, any number of segments can be configured.

What is claimed is:

1. An injection valve, which can be fitted into a cavity of a cylinder head of an internal combustion engine, comprising at least one injection orifice and a nozzle body, which comprises a nozzle body shaft, the nozzle body shaft having a coupling element, which projects radially from the nozzle body shaft and when the injection valve has been fitted, couples the nozzle body shaft mechanically to a lateral surface of the cavity of the cylinder head in a radial direction.

2. The injection valve as claimed in claim 1, wherein the coupling element on the nozzle body shaft has different radii along its axial extension.

3. The injection valve as claimed claim 1, wherein the coupling element is configured and disposed on the nozzle body shaft in such a manner that when the injection valve has been fitted, a free volume is configured between the lateral surface and the nozzle body shaft, which extends from the coupling element on the nozzle body shaft way from the at least one injection orifice and is separated in a sealing manner from a combustion chamber of the internal combustion engine.

4. The injection valve as claimed in claim 1, wherein the coupling element is disposed on the nozzle body shaft in such a manner that when the injection valve has been fitted, it is disposed in an axial end region of the cavity, which faces the combustion chamber (14) of the internal combustion engine.

5. The injection valve as claimed in claim 1, wherein the coupling element is configured and disposed on the nozzle body shaft in such a manner that when the injection valve has been fitted, it forms a thermal coupling between the nozzle body shaft of the injection valve and the lateral surface of the cavity of the cylinder head in a radial direction.

6. The injection valve as claimed in claim 1, wherein the coupling element is configured on at least one predetermined segment of the periphery of the nozzle body shaft.

7. The injection valve as claimed in claim 1, wherein the coupling element is disposed on the nozzle body shaft in such a manner that when the injection valve has been fitted, it is coupled to the cylinder head in a coupling region, in which the cylinder head demonstrates a predetermined temperature gradient during operation of the internal combustion engine.

8. The injection valve as claimed in claim 1, wherein the coupling element is disposed on the nozzle body shaft in such a manner that when the injection valve has been fitted, it is at a predetermined distance from a cooling unit of the cylinder head.

9. The injection valve as claimed in claim 1, wherein the coupling element on the nozzle body shaft comprises copper.

10. The injection valve as claimed in claim 1, wherein the coupling element is configured as a layer on the nozzle body shaft.

11. The injection valve as claimed in claim 10, wherein the layer comprises carbon.

12. The injection valve as claimed in claim 10, wherein the layer comprises a thermally conductive paste.

13. The injection valve as claimed in claim 1, wherein the coupling element on the nozzle body shaft comprises an elastically deformable material.

14. The injection valve as claimed in claim 1, wherein the coupling element is configured as a single piece with the nozzle body shaft.

15. A cylinder head for an internal combustion engine, comprising a cavity, into which an injection valve with a nozzle body shaft can be fitted, and a coupling element on the cylinder head being configured on a lateral surface of the cavity, said coupling element coupling the nozzle body shaft mechanically to the lateral surface in a radial direction, when the injection valve has been fitted.

16. The cylinder head as claimed in claim 15, wherein the coupling element on the cylinder head is configured and disposed in such a manner that when the injection valve has been fitted, a free volume is configured between the lateral surface of the cavity and the nozzle body shaft, which extends from the coupling element on the cylinder head away from a combustion chamber and is separated in a sealing manner from the combustion chamber of the internal combustion engine.

17. The cylinder head as claimed in claim 15, wherein the coupling element on the cylinder head is configured and disposed in such a manner that when the injection valve has been fitted, it forms a thermal coupling between the nozzle body shaft of the injection valve and the lateral surface of the cavity of the cylinder head in a radial direction.

18. The cylinder head as claimed in claim 15, wherein the coupling element on the cylinder head is configured as a layer on the lateral surface of the cavity of the cylinder head.

19. The cylinder head as claimed in claim 17, wherein the layer comprises a thermally conductive paste.

20. The cylinder head as claimed in claim 15, wherein the coupling element on the cylinder head is configured on at least one predetermined segment of the periphery of the lateral surface of the cavity of the cylinder head.
